(19) United States
(12) Patent Application Publication
(10) Pub. No.: US 2024/0174847 A1
(43) Pub. Date: May 30, 2024

(54) POLYPROPYLENE COMPOSITE RESIN COMPOSITION AND A MOLDED ARTICLE CONTAINING THE SAME

(71) Applicants: HYUNDAI MOTOR COMPANY, Seoul (KR); KIA CORPORATION, Seoul (KR); HDC HYUNDAI ENGINEERING PLASTICS CO., LTD., Dangjin-si (KR)

(72) Inventors: In Soo Han, Uiwang-si (KR); Eun Ju Noh, Hwaseong-si (KR); Seul Yi, Seoul (KR); Kyeong Hoon Jang, Seoul (KR); Ju Seong Park, Suwon-si (KR); Jin Bo Chae, Seongnam-si (KR); Eun Seob Shin, Yongin-si (KR)

(73) Assignees: HYUNDAI MOTOR COMPANY, Seoul (KR); KIA CORPORATION, Seoul (KR); HDC HYUNDAI ENGINEERING PLASTICS CO., LTD., Dangjin-si (KR)

(21) Appl. No.: 18/216,783

(22) Filed: Jun. 30, 2023

(30) Foreign Application Priority Data
Nov. 30, 2022 (KR) 10-2022-0163631

(51) Int. Cl. C08L 23/14; C08K 7/16

(52) U.S. Cl. CPC C08L 23/14; C08K 7/16; C08K 2201/005; C08L 2205/025

(57) ABSTRACT

A polypropylene composite resin composition and a molded article including the polypropylene composite resin composition are disclosed. In certain examples, the polypropylene composite resin composition includes an improved elongation and impact strength. The polypropylene composite resin composition may include a first polypropylene copolymer having a melt flow index in a range of 30 g/10 min to 150 g/10 min (230° C., 2.16 kg), a second polypropylene copolymer having a melt flow index in a range of 1 g/10 min to 20 g/10 min (230° C., 2.16 kg), an impact modifier having a Mooney viscosity (ML₁₊₄, 125° C.) in a range of 10 to 70, a dye, and an additive in appropriate amounts.

### CROSS-REFERENCE TO RELATED APPLICATION

This application claims, under 35 U.S.C. § 119(a), the benefit of and priority to Korean Patent Application No. 10-2022-0163631, filed on Nov. 30, 2022, the entire contents of which are incorporated herein by reference.

### BACKGROUND

### (a) Technical Field

The present disclosure relates to a polypropylene composite resin composition and a molded article including the polypropylene composite resin composition.

### (b) Background Art

The statements in this section merely provide background information related to the present disclosure and may not constitute prior art.

In general, polypropylene resin is widely used as a material for injection molded articles because it is lightweight and has superior mechanical properties relative to the price thereof. However, when polypropylene resin is applied as a material for driver airbag covers for unpainted automobiles, cracking or breakage may occur due to extreme force applied to the material.

Therefore, the polypropylene resin is required to have superior low-temperature impact strength and elongation in order to prevent such a phenomenon from occurring.

### SUMMARY OF THE DISCLOSURE

The present disclosure has been made keeping in mind the problems encountered in the related art, and an object of the present disclosure is to provide a polypropylene composite resin composition having improved low-temperature impact strength and elongation compared to conventional polypropylene resins, and a molded article including the same.

The objects of the present disclosure are not limited to the foregoing. The objects of the present disclosure are understood through the following description and to be realized by the means described in the claims and combinations thereof.

A polypropylene composite resin composition is disclosed herein. The polypropylene composite resin composition includes a first polypropylene copolymer having a melt flow index in a range of 30 g/10 min to 150 g/10 min (230° C., 2.16 kg), a second polypropylene copolymer having a melt flow index in a range of 1 g/10 min to 20 g/10 min (230° C., 2.16 kg), an impact modifier having a Mooney viscosity (ML₁₊₄, 125° C.) in a range of 10 to 70, a dye, and an additive.

The polypropylene composite resin composition may include, based on the total weight of the composition, 30 to 60 wt. % of the first polypropylene copolymer, 0.01 to 20 wt. % of the second polypropylene copolymer, 30 to 60 wt. % of the impact modifier, 0.01 to 3 wt. % of the dye, and 0.01 to 5 wt. % of the additive.

Each of the first polypropylene copolymer and the second polypropylene copolymer may have a weight average molecular weight (Mw) in a range of 200,000 to 500,000 g/mol.

Each of the first polypropylene copolymer and the second polypropylene copolymer may have an isotactic index in a range of 97.5 to 99.5% and a specific gravity in a range of 0.89 to 0.99.

Each of the first polypropylene copolymer and the second polypropylene copolymer may include a polypropylene, a homo polypropylene, a highly crystalline block polypropylene, a highly crystalline homo polypropylene, a Metocene polypropylene, a metallocene polypropylene, or combinations thereof.

Each of the first polypropylene copolymer and the second polypropylene copolymer may be a copolymer with an α-olefin monomer. The α-olefin monomer may include ethylene, 1-butene, 1-pentene, 1-hexene, or combinations thereof.

The second polypropylene copolymer may include 30 wt. % or less of ethylene-propylene rubber.

The impact modifier may include an ethylene propylene rubber (EPR), a polyolefin elastomer (POE), an ethylene-octene rubber (EOR), an ethylene-butene rubber (EBR), a styrene-ethylene/butylene-styrene (SEBS), an ethylene propylene monomer (EPM), an ethylene propylene diene monomer (EPDM), or combinations thereof.

The dye may be an inorganic color powder having a particle size (D50) of 100 micrometers (μm) or less.

The dye may include iron oxide, carbon black, chromium, antimony, titanium, rutile, zinc, stearic acid, or combinations thereof.

The additive may include an antioxidant, a heat stabilizer, a light stabilizer, a lubricant, an antistatic agent, or combinations thereof.

In addition, a molded article is provided, wherein the molded article includes the polypropylene composite resin composition described herein.

The molded article may have an Izod room-temperature impact strength (23° C.) in a range of 53 to 63 kJ/m² and an Izod low-temperature impact strength (−35° C.) in a range of 68 to 93 kJ/m² as measured according to ISO 180.

The molded article may have hardness (Shore D) in a range of 34 to 49 as measured according to ISO 868.

### DETAILED DESCRIPTION

The above and other objects, features, and advantages of the present disclosure are more clearly understood from the following embodiments. However, the present disclosure is not limited to the embodiments disclosed herein, and may be modified into different forms. These embodiments are provided to thoroughly explain the disclosure and to sufficiently transfer the spirit of the present disclosure to those skilled in the art.

The terms “comprise,” “include,” “have,” etc., when used in this specification, specify the presence of stated features, integers, steps, operations, elements, components, or combinations thereof, but do not preclude the presence or addition of one or more other features, integers, steps, operations, elements, components, or combinations thereof.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of the range to the maximum value thereof, unless otherwise indicated. Moreover, when such a range pertains to integer values, all integers including the minimum value to the maximum value are included, unless otherwise indicated.

A polypropylene composite resin composition includes a first polypropylene copolymer having a melt flow index in a range of 30 g/10 min to 150 g/10 min (230° C., 2.16 kg), a second polypropylene copolymer having a melt flow index in a range of 1 g/10 min to 20 g/10 min (230° C., 2.16 kg), an impact modifier having a Mooney viscosity (ML₁₊₄, 125° C.) in a range of 10 to 70, a dye, and an additive.

The term “melt flow index” is an index representing melt flowability of a plastic material at a certain temperature under a certain load, and a melt index within an appropriate range may be selected in consideration of all mechanical properties.

Individual components constituting the polypropylene composite resin composition according to the present disclosure are specified below.

### (A) First Polypropylene Copolymer

The first polypropylene copolymer may include a low-viscosity polypropylene copolymer having high tensile strength in order to increase flowability and tensile strength that are decreased due to the use of an impact modifier described later.

Therefore, the polypropylene composite resin composition may include, as a base resin, the second polypropylene copolymer having a wide molecular weight distribution and the first polypropylene copolymer having low viscosity in order to improve the molecular weight distribution and flowability of the material.

The first polypropylene copolymer may have a melt flow index in a range of 30 g/10 min to 150 g/10 min, as measured at 230° C. under a load of 2.16 kg. If the melt flow index of the first polypropylene copolymer is less than 30 g/10 min (230° C., 2.16 kg), processing during injection may become difficult due to low flowability. On the other hand, if the melt flow index of the first polypropylene copolymer exceeds 150 g/10 min (230° C., 2.16 kg), balance between stiffness and impact resistance of the injection molded product may be lowered, which is undesirable.

The first polypropylene copolymer may be included in an amount in a range of 30 to 60 wt. % based on the total weight of the composition. If the amount of the first polypropylene copolymer is less than 30 wt. %, stiffness may be reduced, making it impossible to use the same as a material for automobile interiors, and thus, ethylene may be included within the above described range. On the other hand, if the amount of the first polypropylene copolymer exceeds 60 wt. %, stiffness may be reduced, making it impossible to use the same as a material for automobile interiors. Hence, the amount thereof may fall within the above described range.

The first polypropylene copolymer is a copolymer with α-olefin monomer, and the olefin monomer may include ethylene, 1-butene, 1-pentene, 1-hexene, or combinations thereof.

The first polypropylene copolymer may include a homopolymer and a copolymer. Specifically, the first polypropylene copolymer may include a block polypropylene, a homo polypropylene, a highly crystalline block polypropylene, a highly crystalline homo polypropylene, a Metocene polypropylene, a metallocene polypropylene, or combinations thereof.

The first polypropylene copolymer may have a weight average molecular weight (Mw) in a range of 200,000 to 500,000 g/mol, an isotactic index (I.I) in a range of 97.5 to 99.5%, and a specific gravity in a range of 0.89 to 0.99.

### (B) Second Polypropylene Copolymer

The second polypropylene copolymer may include a high-impact-resistance polypropylene copolymer having a wide molecular weight distribution in order to attain appearance quality.

Therefore, the polypropylene composite resin composition may reduce occurrence of flow marks during injection due to the use of the high-impact-resistance polypropylene copolymer.

The second polypropylene copolymer may have a wide molecular weight distribution (MWD) in a range of 27 to 512. Here, the molecular weight distribution (MWD) is a value obtained by dividing the weight average molecular weight (Mw) by the number average molecular weight (Mn), and this molecular weight distribution is greatly associated with processing moldability and physical properties. The lower the molecular weight distribution (MWD), the better the balance between stiffness and impact strength, but the injection moldability may be poor. In contrast, the higher the molecular weight distribution (MWD), the better the injection moldability, but the stiffness may be lowered. Here, if the molecular weight distribution of the second polypropylene copolymer is less than 27, impact strength may be improved but processability may be deteriorated, whereas if the molecular weight distribution is greater than 512, flowability may be good but stiffness may be deteriorated.

The second polypropylene copolymer may have a melt flow index in a range of 1 g/10 min to 20 g/10 min, as measured at 230° C. under a load of 2.16 kg.

If the melt flow index of the second polypropylene copolymer is less than 1 g/10 min (230° C., 2.16 kg), processing during injection may become difficult due to low flowability, whereas if the melt flow index of the second polypropylene copolymer exceeds 20 g/10 min (230° C., 2.16 kg), impact strength of the injection molded product may be deteriorated.

The second polypropylene copolymer may be included in an amount in a range of 20 wt. % or less based on the total weight of the composition. Specifically, the second polypropylene copolymer may be included in an amount in a range of 0.01 to 20 wt. % based on the total weight of the composition. If the amount of the second polypropylene copolymer exceeds 20 wt. %, stiffness may be reduced, making it impossible to use the same as a material for automobile interiors. Hence, the amount thereof may fall within the above described range.

The second polypropylene copolymer is a copolymer with α-olefin monomer, and the olefin monomer may include ethylene, 1-butene, 1-pentene, 1-hexene, or combinations thereof.

The polypropylene may include a homopolymer and a copolymer. Specifically, the second polypropylene copolymer may include a block polypropylene, a homo polypropylene, a highly crystalline block polypropylene, a highly crystalline homo polypropylene, a Metocene polypropylene, a metallocene polypropylene, or combinations thereof.

The second polypropylene copolymer may have a weight average molecular weight (Mw) in a range of 200,000 to 500,000 g/mol, an isotactic index (I.I) in a range of 97.5 to 99.5%, and a specific gravity in a range of 0.89 to 0.99.

The second polypropylene copolymer may include 30 wt. % or less of an ethylene-propylene rubber component.

### (C) Impact Modifier

The impact modifier may be added in excess in order to improve low-temperature (0 to −35° C.) impact strength and elongation.

The impact modifier may be included in an amount in a range of 30 to 60 wt. % based on the total weight of the composition. If the amount of the impact modifier is less than 30 wt. %, impact strength may not be good. On the other hand, if the amount of the impact modifier exceeds 60 wt. %, stiffness may be lowered, which is undesirable.

The impact modifier may affect the shrinkage of the molded article, which has an influence on dimensional stability of parts, so the impact modifier may be provided or used in an amount in a range of 30 to 60 wt. % in order to produce a molded article having appropriate strength and stiffness.

The impact modifier may have a Mooney viscosity (ML₁₊₄, 125° C.) in a range of 10 to 70 as measured according to ASTM D1646. The Mooney viscosity is an index representing the viscosity of synthetic rubber measured by a Mooney plastometer.

The impact modifier may include an ethylene propylene rubber (EPR), a polyolefin elastomer (POE), an ethylene-octene rubber (EOR), an ethylene-butene rubber (EBR), a styrene-ethylene/butylene-styrene (SEBS), an ethylene propylene monomer (EPM), an ethylene propylene diene monomer (EPDM), or combinations thereof.

### (D) Dye

The dye makes it possible to realize the appearance of molded articles without painting.

The dye may be included in an amount of 3 wt. % or less based on the total weight of the composition. Specifically, the dye may be included in an amount in a range of 0.01 to 3 wt. % based on the total weight of the composition. If the amount of the dye is less than 0.01 wt. %, exterior gloss cannot be obtained as desired. On the other hand, if the amount of the dye exceeds 3 wt. %, a large amount of gas may be generated, and marks may be left on the exterior, which may deteriorate the appearance and reliability of parts.

The dye may be an inorganic color powder having a particle size (D50) of 100 micrometers (μm) or less. Specifically, the dye may have a particle size (D50) in a range of 0.01 to 100 μm. Here, the particle size (D50) is the average particle diameter and indicates the value of D50.

If the particle size (D50) of the dye is less than 0.01 μm, the particle size is too small and the effect of addition is insignificant, whereas if the particle size (D50) of the dye exceeds 100 μm, mechanical properties such as stiffness may be deteriorated.

The dye may include iron oxide, carbon black, chromium, antimony, titanium, rutile, zinc, stearic acid, or combinations thereof.

### (E) Additive

The additive is used to impart various functionalities to the polypropylene composite resin composition, and additives commonly used in the art may be used without particular limitation within a range that does not impair the effects of the present disclosure.

The additive may include an antioxidant, a heat stabilizer, a light stabilizer, a lubricant, an antistatic agent, or combinations thereof.

The additive may be included in an amount of 5 wt. % or less based on the total weight of the composition. Specifically, the additive may be included in an amount in a range of 0.01 to 5 wt. % based on the total weight of the composition. In particular, although polymers may undergo cracking or oxidation depending on the dose of light irradiated, in order to prevent such phenomena, an appropriate amount of plastic additive may be added to impart stability on external environmental stimuli. Specifically, the plastic additive may include an antioxidant.

Another aspect of the present disclosure pertains to a molded article including the polypropylene composite resin composition described herein. The molded article may have an Izod room-temperature impact strength (23° C.) in a range of 53 to 63 kJ/m² and an Izod low-temperature impact strength (−35° C.) in a range of 68 to 93 kJ/m² as measured according to ISO 180.

In addition, the molded article may have hardness (Shore D) in a range of 34 to 49 as measured according to ISO 868.

Because the molded article according to the present disclosure has superior impact strength and elongation properties, the molded article may be applied to or integrated within home appliances and automobile exterior and interior parts.

In particular, the molded article is not limited in the field of use thereof but may be applied to a material for driver airbag covers for unpainted automobiles.

Meanwhile, driver airbag covers that have been produced to date are commercialized after the painting process due to appearance quality problems (flow marks, weld lines, etc.) during injection. Therefore, in order to eliminate the painting process, it is important to attain appearance quality during injection.

Thus, the polypropylene composite resin composition has the advantage of high production efficiency by eliminating the painting process after the injection process because a TPO (thermoplastic olefin) material may be prepared using a simple extrusion process and through dye input. Hence, VOC emissions may be reduced by eliminating the painting process, thereby minimizing the occupant's exposure to environmental pollution.

Therefore, the polypropylene composite resin composition is capable of providing a material for a driver airbag cover for an unpainted automobile exhibiting superior appearance quality, impact strength, and elongation.

A better understanding of the present disclosure may be obtained through the following examples. These examples are merely set forth to illustrate the present disclosure and are not to be construed as limiting the scope of the present disclosure.

Polypropylene composite resin compositions were prepared through a typical method by mixing components in the amounts shown in Tables 1 and 2 below.

### Individual Components for Composition

First polypropylene: Low-viscosity polypropylene copolymer (MI: 140 g/10 min), with weight average molecular weight (Mw) in a range of 200,000 to 500,000 g/mol, isotactic index in a range of 97.5 to 99.5%, and specific gravity in a range of 0.89 to 0.99

Second polypropylene: High-impact-resistance polypropylene copolymer (MI: 10 g/10 min), with weight average molecular weight (Mw) in a range of 200,000 to 500,000g/mol, isotactic index in a range of 97.5 to 99.5%, and specific gravity in a range of 0.89 to 0.99

Impact modifier: Ethylene propylene monomer (EPM), with Mooney viscosity of 60 to 70 ML₁₊₄ (ASTM D1646)

Additive: Antioxidant, etc.

Dye: Inorganic color powder, with particle size (D50) of 100 μm or less

Dye: Iron oxide, carbon black, chromium, antimony, titanium, rutile, zinc, stearic acid, or combinations thereof

TABLE 1

| | Exam- | Exam- | Exam- | Exam- | Exam- |
|---|---|---|---|---|---|
| Composition (wt. %) | ple 1 | ple 2 | ple 3 | ple 4 | ple 5 |
| (B) Second | 16 | 11 | 6 | 10 | 19 |
| polypropylene | | | | | |
| (A) First polypropylene | 36 | 41 | 46 | 42 | 32 |
| (C) Impact modifier | 42 | 42 | 42 | 42 | 42 |
| (D) Additive | 4 | 4 | 4 | 4 | 4 |
| (E) Dye | 2 | 2 | 2 | 2 | 2 |

TABLE 2

| | Comp. | Comp. | Comp. | Comp. | Comp. | Comp. | Comp. |
|---|---|---|---|---|---|---|---|
| Composition | Example | Example | Example | Example | Example | Example | Example |
| (wt. %) | 1 | 2 | 3 | 4 | 5 | 6 | 7 |
| (B) Second | 72 | — | 36 | 31 | 26 | 21 | — |
| polypropylene | | | | | | | |
| (A) First | — | 72 | 36 | 31 | 26 | 31 | 52 |
| polypropylene | | | | | | | |
| (C) Impact | 22 | 22 | 22 | 32 | 42 | 42 | 42 |
| modifier | | | | | | | |
| (D) Additive | 4 | 4 | 4 | 4 | 4 | 4 | 4 |
| (E) Dye | 2 | 2 | 2 | 2 | 2 | 2 | 2 |

### Test Example

The physical properties of test specimens manufactured through a typical injection process using the polypropylene composite resin compositions according to Examples and Comparative Examples were measured as follows. The results thereof are shown in Tables 3 and 4 below.

### Evaluation Methods

MI (g/10 min): Melt flow index measurement was performed under a stress load of 21.2 N at 230° C. according to ISO 1133.

Specific gravity (g/cm3): Measurement was performed according to ISO 1183.

Elongation (%), tensile strength (MPa): Measurement was performed under TYPE 1 at a speed 450 mm/min according to ISO 527-1.

Flexural modulus (MPa): Measurement was performed at a speed of 2 mm/min according to ISO 178.

Izod impact strength (kJ/m²): Measurement was performed at room temperature (23° C.) and a low temperature (−35° C.) according to ISO 180.

Heat deflection temperature (HDT, ° C.: Measurement was performed under a stress load of 0.45 MPa according to ISO 75.

Shore D hardness: Measurement was performed according to ISO 868.

TABLE 3

| Properties | Example 1 | Example 2 | Example 3 | Example 4 | Example 5 |
|---|---|---|---|---|---|
| (1) MI (230° C., g/10 min) | 9.4 | 5.9 | 13.0 | 11.9 | 8.7 |
| (2) Specific gravity (g/cm³) | 0.893 | 0.893 | 0.892 | 0.895 | 0.892 |
| (3) Elongation (%) | 455 | 610 | 330 | 340 | 679 |
| (3) Tensile strength (MPa) | 12.1 | 9.9 | 14.1 | 10.7 | 9.2 |
| (4) Flexural modulus (MPa) | 428 | 374 | 503 | 385 | 308 |
| (5) IZOD room-temperature | 53.2 | 61.1 | 61.4 | 62.9 | 53.2 |
| impact strength (kJ/m²) | | | | | |
| (5) IZOD low-temperature | 75.3 | 76.9 | 78.6 | 92.2 | 80.3 |
| impact strength (kJ/m²) | | | | | |
| (6) HDT (° C.) | 76.6 | 67.9 | 71.1 | 65.6 | 76.6 |
| (7) Shore D hardness | 34.5 | 37 | 46 | 41 | 45 |

TABLE 4

| | Comp. | Comp. | Comp. | Comp. | Comp. | Comp. | Comp. |
|---|---|---|---|---|---|---|---|
| | Example | Example | Example | Example | Example | Example | Example |
| Properties | 1 | 2 | 3 | 4 | 5 | 6 | 7 |
| (1) MI (230° C., g/10 | 5.6 | 61.9 | 25.8 | 15.4 | 14.7 | 11.7 | 19.1 |
| min) | | | | | | | |
| (2) Specific gravity | 0.895 | 0.893 | 0.894 | 0.897 | 0.894 | 0.895 | 0.892 |
| (g/cm³) | | | | | | | |
| (3) Elongation (%) | 320 | 351 | 280 | 610 | 491 | 427 | 328 |
| (3) Tensile strength | 14.5 | 21 | 18.8 | 9.9 | 15.7 | 14.2 | 12 |
| (MPa) | | | | | | | |
| (4) Flexural modulus | 800 | 1,029 | 929 | 374 | 212 | 582 | 382 |
| (MPa) | | | | | | | |
| (5) IZOD room- | 61.1 | 42.5 | 46.6 | 50.1 | 75 | 64.2 | 57.1 |
| temperature impact | | | | | | | |
| strength (kJ/m²) | | | | | | | |
| (5) IZOD low- | 32.6 | 20.2 | 28.4 | 39.4 | 14.2 | 20.2 | 68.4 |
| temperature impact | | | | | | | |
| strength (kJ/m²) | | | | | | | |
| (6) HDT (° C.) | 77.5 | 77.4 | 76.6 | 67.9 | 89.5 | 77.4 | 68.8 |
| (7) Shore D hardness | 90 | 91 | 91 | 74 | 48 | 45 | 49 |

With reference to Tables 3 and 4, in Comparative Example 1, in which the second polypropylene copolymer was excessively added without using the first polypropylene copolymer, Izod low-temperature impact strength was very low compared to Examples according to the present disclosure.

Also, in Comparative Example 2, in which the amount of the first polypropylene copolymer exceeded 60 wt. % without using the second polypropylene copolymer exhibited very low Izod room-temperature and low-temperature impact strength compared to Examples according to the present disclosure. Moreover, Comparative Example 1 showed a very low melt flow index.

Also, in Comparative Example 3, in which the amount of the second polypropylene copolymer exceeded 20 wt. % and the amount of the impact modifier was less than 30 wt. %, Izod room-temperature and low-temperature impact strength and elongation were very low compared to Examples according to the present disclosure.

Also, in Comparative Example 4, in which the amount of the second polypropylene copolymer exceeded 20 wt. %, Izod low-temperature impact strength was very low compared to Examples according to the present disclosure.

Also, in Comparative Example 5, in which the amount of the second polypropylene copolymer exceeded 20 wt. % and the first polypropylene copolymer was added in a small amount, Izod low-temperature impact strength and flexural modulus were very low compared to Examples according to the present disclosure.

Also, in Comparative Example 6, in which the amount of the second polypropylene copolymer exceeded 20 wt. %, Izod low-temperature impact strength was very low compared to Examples according to the present disclosure.

Also, in Comparative Example 7, in which the second polypropylene copolymer was not used, elongation was poor compared to Examples according to the present disclosure.

Therefore, the specimens according to Comparative Examples 1 to 7 were imbalanced in elongation, tensile strength, flexural modulus, Izod impact strength, hardness, and heat deflection temperature compared to Examples according to the present disclosure, and this imbalance significantly deteriorated various characteristics of the final product.

In contrast, Examples 1 to 5, in which the first polypropylene copolymer having a melt index in a specific range, the second polypropylene copolymer having a melt index in a specific range, the impact modifier, the dye, and the additive were mixed in appropriate amounts, exhibited improved Izod low-temperature impact strength and elongation while maintaining existing mechanical properties (high stiffness).

Therefore, the polypropylene composite resin composition according to the present disclosure, in which individual components are used in appropriate amounts, is capable of exhibiting superior low-temperature impact strength and elongation at the same time, compared to conventional polypropylene resins.

As is apparent from the above description, a polypropylene composite resin composition is capable of attaining appearance quality while exhibiting improved low-temperature impact strength and elongation compared to conventional polypropylene resins by mixing a first polypropylene copolymer, a second polypropylene copolymer, an impact modifier, a dye, and an additive in specific amounts.

In addition, a molded article has the advantage of superior production efficiency because the painting process is eliminated after the injection process.

In addition, the molded article has superior impact strength and elongation properties, and can thus be applied to home appliances, exterior and interior parts of automobiles, and materials for driver airbag covers for unpainted automobiles.

The effects of the present disclosure are not limited to the above-mentioned effects. It should be understood that the effects of the present disclosure include all effects that can be inferred from the description of the present disclosure.

Although specific embodiments of the present disclosure have been described herein, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. A polypropylene composite resin composition comprising:
a first polypropylene copolymer having a melt flow index in a range of 30 g/10 min to 150 g/10 min (230° C., 2.16 kg);
a second polypropylene copolymer having a melt flow index in a range of 1 g/10 min to 20 g/10 min (230° C., 2.16 kg);
an impact modifier having a Mooney viscosity (ML₁₊₄, 125° C.) in a range of 10 to 70;
a dye; and
an additive.

2. The polypropylene composite resin composition of claim 1, wherein the polypropylene composite resin composition comprises, based on a total weight of the polypropylene composite resin composition,
30 to 60 wt. % of the first polypropylene copolymer;
0.01 to 20 wt. % of the second polypropylene copolymer;
30 to 60 wt. % of the impact modifier;
0.01 to 3 wt. % of the dye; and
0.01 to 5 wt. % of the additive.

3. The polypropylene composite resin composition of claim 1, wherein the first polypropylene copolymer and the second polypropylene copolymer each have a weight average molecular weight (Mw) in a range of 200,000 to 500,000 g/mol.

4. The polypropylene composite resin composition of claim 1, wherein the first polypropylene copolymer and the second polypropylene copolymer each have an isotactic index in a range of 97.5 to 99.5% and a specific gravity in a range of 0.89 to 0.99.

5. The polypropylene composite resin composition of claim 1, wherein the first polypropylene copolymer and the second polypropylene copolymer each independently comprise a block polypropylene, a homo polypropylene, a highly crystalline block polypropylene, a highly crystalline homo polypropylene, a Metocene polypropylene, a metallocene polypropylene, or combinations thereof.

6. The polypropylene composite resin composition of claim 1, wherein the first polypropylene copolymer and the second polypropylene copolymer each independently comprises a copolymer with an α-olefin monomer, and wherein the olefin monomer comprises ethylene, 1-butene, 1-pentene, 1-hexene, or combinations thereof.

7. The polypropylene composite resin composition of claim 1, wherein the second polypropylene copolymer comprises 30 wt. % or less of an ethylene-propylene rubber.

8. The polypropylene composite resin composition of claim 1, wherein the impact modifier comprises an ethylene propylene rubber (EPR), a polyolefin elastomer (POE), an ethylene-octene rubber (EOR), an ethylene-butene rubber (EBR), a styrene-ethylene/butylene-styrene (SEBS), an ethylene propylene monomer (EPM), an ethylene propylene diene monomer (EPDM), or combinations thereof.

9. The polypropylene composite resin composition of claim 1, wherein the dye is an inorganic color powder having a particle size (D50) in a range of 100 μm or less.

10. The polypropylene composite resin composition of claim 1, wherein the dye comprises iron oxide, carbon black, chromium, antimony, titanium, rutile, zinc, stearic acid, or combinations thereof.

11. The polypropylene composite resin composition of claim 1, wherein the additive comprises an antioxidant, a heat stabilizer, a light stabilizer, a lubricant, an antistatic agent, or combinations thereof.

12. A molded article comprising:
a polypropylene composite resin composition having:
a first polypropylene copolymer having a melt flow index in a range of 30 g/10 min to 150 g/10 min (230° C., 2.16 kg);
a second polypropylene copolymer having a melt flow index in a range of 1 g/10 min to 20 g/10 min (230° C., 2.16 kg);
an impact modifier having a Mooney viscosity (ML₁₊₄, 125° C.) in a range of 10 to 70;
a dye; and
an additive.

13. The molded article of claim 12, wherein the molded article has an Izod room-temperature impact strength (23° C.) in a range of 53 to 63 kJ/m² as measured according to ISO 180, and
wherein the molded article has an Izod low-temperature impact strength (−35° C.) in a range of 68 to 93 kJ/m² as measured according to ISO 180.

14. The molded article of claim 12, wherein the molded article has a hardness (Shore D) in a range of 34 to 49 as measured according to ISO 868.
